(19) United States
(12) Patent Application Publication
(10) Pub. No.: US 2015/0288710 A1
(43) Pub. Date: Oct. 8, 2015

(54) APPLICATION-AWARE SIGNATURE-BASED INTRUSION DETECTION FOR VIRTUALIZED DATA CENTERS

(71) Applicant: Guardicore Ltd., Tel Aviv (IL)

(72) Inventors: Ariel Zeitlin, Kfar Saba (IL); Ori Aldor, Ganey Tikva (IL)

(21) Appl. No.: 14/642,955

(22) Filed: Mar. 10, 2015

Related U.S. Application Data
(60) Provisional application No. 61/976,632, filed on Apr. 8, 2014.

(51) Int. Cl. H04L 29/06; G06F 9/455

(52) U.S. Cl. CPC H04L 63/1416; G06F 9/45558; H04L 63/1441; G06F 2009/45587

(57) ABSTRACT

A method includes discovering identities of one or more applications that run on one or more Virtual Machines (VMs) at a given time. A set of signatures, which characterize hostile traffic that is expected to threaten the discovered applications, is selected. Network traffic exchanged with the one or more VMs for is searched for the hostile traffic using the selected set of signatures.

### CROSS-REFERENCE TO RELATED APPLICATIONS

This application claims the benefit of U.S. Provisional Patent Application 61/976,632, filed Apr. 8, 2014, whose disclosure is incorporated herein by reference.

### FIELD OF THE INVENTION

The present invention relates generally to network security, and particularly to methods and systems for intrusion detection and prevention.

### BACKGROUND OF THE INVENTION

Various techniques for detecting hostile communication traffic are known in the art. Some known techniques search the traffic for patterns that are known to characterize hostile traffic. Such techniques are implemented, for example, in Intrusion Detection Systems (IDSs), Intrusion Prevention Systems (IPSs) and firewalls.

### SUMMARY OF THE INVENTION

An embodiment of the present invention that is described herein provides a method including discovering identities of one or more applications that run on one or more Virtual Machines (VMs) at a given time. A set of signatures, which characterize hostile traffic that is expected to threaten the discovered applications, is selected. Network traffic exchanged with the one or more VMs for is searched for the hostile traffic using the selected set of signatures.

In some embodiments, discovering the identities, selecting the signatures and searching the network traffic are performed by a hypervisor that hosts the one or more VMs. In an embodiment, discovering the identities includes identifying a newly-invoked application, and selecting the signatures includes requesting an external source to update the set with one or more signatures associated with the newly-invoked application. Additionally or alternatively, discovering the identities may include identifying an application that previously ran but no longer runs on the one or more VMs, and selecting the signatures includes removing one or more signatures associated with the application from the set.

In another embodiment, discovering the identities of the applications includes examining processes running in the VMs using memory introspection. In yet another embodiment, discovering the identities of the applications includes identifying communication traffic of the VMs that is indicative of the applications that run on the VMs. In still another embodiment, discovering the identities of the applications includes receiving the identities of the applications from a management system.

In a disclosed embodiment, the set of signatures is embedded as a data structure in a search-engine software that searches the network traffic. The method may include, in response to detecting a change in the identities of the applications, requesting an external source for an updated version of the data structure, and embedding the updated version in the search-engine software.

In some embodiments, discovering the identities includes initiating discovery of the identities in response to a predefined trigger. The predefined trigger may include at least one trigger type selected from a group of types consisting of a periodic re-discovery cycle, an administrator request, addition or removal of an application in one or more of the VMs, addition or removal of one of the VMs, and a change in a global database of the signatures.

There is additionally provided, in accordance with an embodiment of the present invention, an apparatus including a memory and a processor. The memory is configured for storing traffic signatures. The processor is configured to discover identities of one or more applications that run on one or more Virtual Machines (VMs) at a given time, to select and store in the memory a set of signatures, which characterize hostile traffic that is expected to threaten the discovered applications, and to search network traffic exchanged with the one or more VMs for the hostile traffic, using the selected set of signatures.

There is further provided, in accordance with an embodiment of the present invention, a system including multiple hosts. Each host is configured to run one or more respective Virtual Machines (VMs), to discover identities of one or more applications that run on the Virtual Machines (VMs) in the host at a given time, to select a respective set of signatures that characterize hostile traffic that is expected to threaten the discovered applications, and to search network traffic exchanged with the one or more VMs in the host for the hostile traffic, using the selected set of signatures.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computing system that uses application-aware intrusion detection, in accordance with an embodiment of the present invention; and

FIG. 2 is a flow chart that schematically illustrates a method for application-aware intrusion detection, in accordance with an embodiment of the present invention.

### DETAILED DESCRIPTION OF EMBODIMENTS

### Overview

Embodiments of the present invention that are described herein provide improved methods and systems for protecting Virtual Machines (VMs) from hostile attacks. The disclosed techniques can be used, for example, in virtualized data centers that comprise multiple physical hosts, each running a respective hypervisor that hosts one or more VMs.

In some embodiments, each hypervisor runs a local discovery module, a local search engine and a local signature database. The discovery module in each host discovers the identities of the applications that currently run on the VMs of that host, e.g., using VM memory introspection. The discovery module configures the local signature database with signatures of hostile traffic known to threaten the discovered applications. The local search engine scans the traffic of the hosted VMs using the signatures in the local signature database.

The process of discovering the applications and configuring the local signature database is typically repeated periodically and/or in response to various events. A similar process is carried out individually in each host. The set of signatures may differ from one host to another, depending on the applications that run on the VMs in each host.

The disclosed techniques use the visibility that the hypervisor has into the internal processes of the VMs, for discovering the identities of the applications that the VMs actually run at any given time. In addition, the disclosed techniques use the fact that, for a given host at a given time, most signatures correspond to malware types that do not actually threaten the host, e.g., because they threaten operating systems, applications or versions of applications that the host VMs do not actually run.

When using the disclosed techniques, each local search engine uses only a small set of signatures at any given time—The signatures of hostile traffic known to threaten the specific applications that currently run on the host. Since this set is only a small fraction of the overall collection of known signatures, the search is fast, and the processing power and memory requirements in each hypervisor are kept small and manageable.

### SYSTEM DESCRIPTION

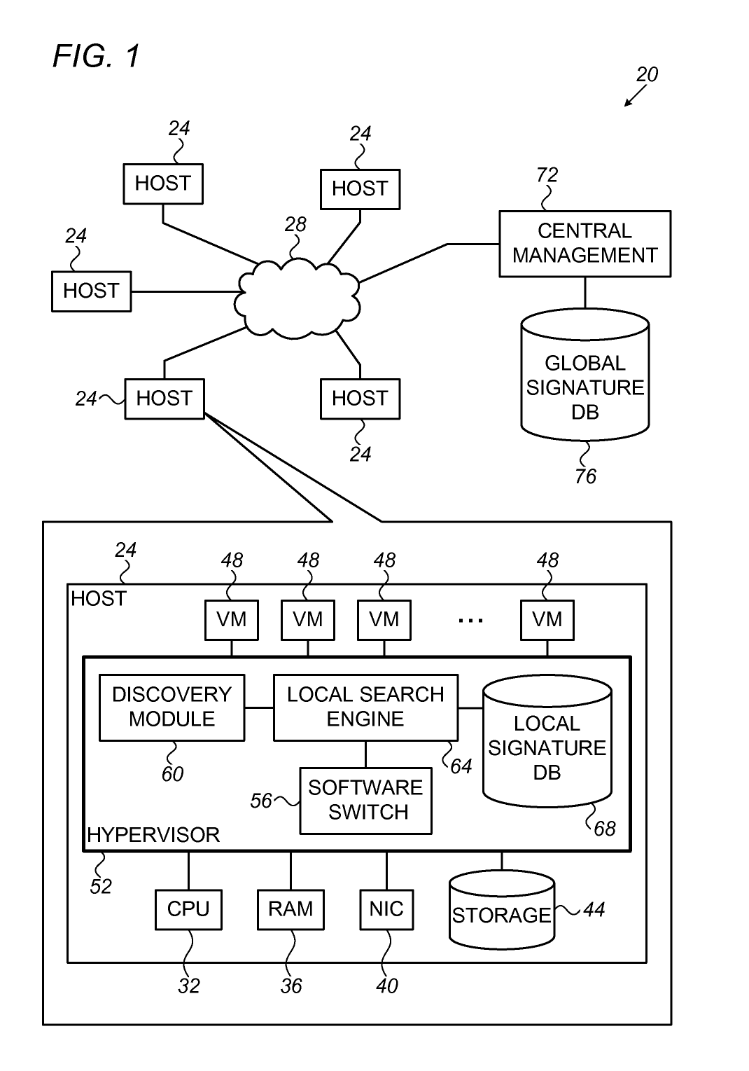

FIG. 1 is a block diagram that schematically illustrates a computing system 20 that uses application-aware intrusion detection, in accordance with an embodiment of the present invention. System 20 may comprise, for example, a virtualized data center or any other suitable computing system type.

System 20 comprises multiple physical hosts 24 interconnected by a communication network 28. Hosts 24 may comprise, for example, servers, workstations or any other suitable computing platform. Network 28 may comprise, for example, an Ethernet or Infiniband Local-Area Network (LAN), or any other suitable type of network.

The bottom of FIG. 1 shows the structure of one host in greater detail. The other hosts typically have a similar structure. In the present example, each host comprises physical resources such as a Central Processing Unit (CPU) 32, Random Access Memory (RAM) 36, Network Interface Card (NIC) and persistent storage device 44.

Each host 24 runs one or more Virtual Machines (VMs) using a hypervisor 52. The hypervisor is typically implemented as a software layer that runs on CPU 32 and stores data in RAM 36. Among other tasks, the hypervisor allocates physical resources of the host (e.g., CPU, RAM, NIC and storage resources) to the various VMs. Hypervisor 52 comprises a software switch 56, possibly a fabric of several switches, which forwards communication traffic for the VMs of the host, including both internal traffic among the VMs of the host and external traffic to/from outside the host.

In addition, hypervisor 52 in each host runs a respective discovery module 60, local search engine 64 and local signature database 68, which jointly protect the VMs of the host from hostile traffic. The functions of these components are explained in detail below. In each host, discovery module 60 and search engine 64 typically comprise software modules that execute on CPU 32. Signature database 68 is typically stored in RAM 36. System 20 further comprises a central management unit 72 and a global signature database 76, whose role is also addressed below.

The system and host configurations shown in FIG. 1 are example configurations, which are chosen purely for the sake of conceptual clarity. In alternative embodiments, any other suitable system and host configurations can be used. For example, the functions of discovery module 60 and search engine 64 can be partitioned in any desired manner using one or more software modules that run on CPU 32. Signature database 68 may be implemented using any suitable data structure residing in a memory of the host, e.g., in RAM 36.

The different system and host elements shown in FIG. 1 may be implemented using any suitable hardware, such as in an Application-Specific Integrated Circuit (ASIC) or Field-Programmable Gate Array (FPGA). Alternatively, the various system and host elements can be implemented using software, or using a combination of hardware and software elements.

In some embodiments, CPUs 32 and/or central management unit 72 may comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Distributed Application-Aware Intrusion Detection

In a typical use-case, system 20 comprises a large number of VMs that run various applications of various versions. Applications may comprise, for example, an operating system, a web server, an e-mail server, an Apache server or a database, to name just a few examples. As such, VMs 48 may be threatened by a large variety of hostile attacks, e.g., viruses, worms or Trojan horses.

One possible way of protecting against such attacks is to search the traffic in system 20 for traffic patterns (referred to as “signatures”) that are known to characterize hostile traffic. Due to the large number of possible applications, versions and threats, a naive protection scheme would need to search the traffic using a huge number of signatures, on the order of hundreds or even thousands. The computational complexity and memory requirements incurred by such a solution, however, may be prohibitive, especially in large and diverse data centers.

On the other hand, the actual number of signatures that are needed in a given host at a given time is usually very small. For example, the VMs of a given host may run a particular operating system, and therefore signatures of malware that exploits vulnerabilities of other operating systems are irrelevant. As another example, signatures of malware that targets a certain application are irrelevant in a host whose VMs do not run this application. As yet another example, the VMs of a given host may run the latest version of an application that is protected (“patched”) against all known threats. In such a case, all known signatures are irrelevant for this application.

In some embodiment of the present invention, hypervisor 52 in each host 24 discovers the identities of the specific applications that currently run in the VMs of the host. The hypervisor searches the traffic exchanged with the VMs of the host using only the signatures that are expected to threaten the discovered applications. In this manner, each hypervisor typically needs to consider only a small number of signatures at any given time.

In some embodiments, local signature database 68 in each hypervisor is embedded in local search engine 64 as a state-machine or other efficiently-searchable data structure. In some embodiments, local signature database 68 may be compiled and updated locally by the hypervisor.

In alternative embodiments, the data structure is compiled by central management unit 72, per a specific set of signatures requested by discovery module 60 of that host, and delivered to local search engine 64 upon request. In these embodiments, central management unit 72 also re-compiles and updates this data structure for the local search engine, in response to a change in the discovered applications. A change may comprise adding and/or removing one or more signatures from local database 68. Such embodiments may be useful, for example, in hypervisors having limited computational power.

In some embodiments, central management unit 72 is also responsible for communicating with local search engines 64 of the various hypervisors, checking their health, collecting reports regarding detected attack patterns, performing version updates, and handling various other administrative tasks.

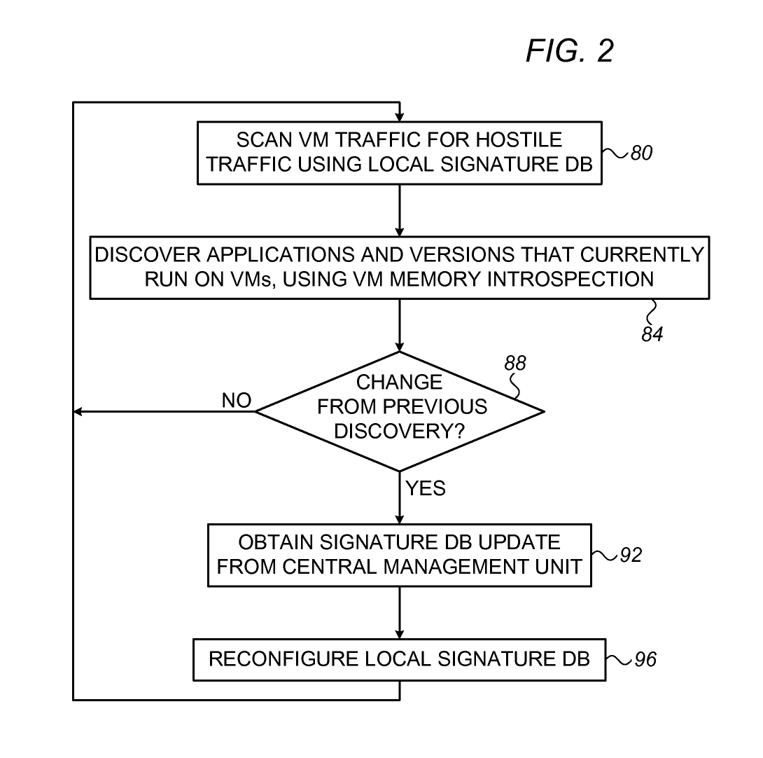

FIG. 2 is a flow chart that schematically illustrates a method for application-aware intrusion detection, in accordance with an embodiment of the present invention. The figure shows the process carried out in a given hypervisor 32. A similar process is performed by the other hypervisors in system 20.

The method begins with local search engine 64 scanning the traffic exchanged with the VMs hosted by the hypervisor, at a scanning step 80. The scanned traffic typically comprises external traffic exchanged between the VMs and other entities outside hypervisor 32, as well as internal traffic among the VMs of the hypervisor. Search engine 64 typically monitors the VM traffic by interfacing with software switch 56.

In the scanning operation, the search engine attempts to match the traffic to the signatures that are currently configured in local signature database 68. The local signature database is assumed to be initialized with some initial set of signatures. If a match is found, search engine 64 takes appropriate action, e.g., notifies central management unit 72 and/or isolates the attacked VM.

At a discovery step 84, local discovery module 60 discovers the identities of the applications that currently run in the VMs hosted by hypervisor 32. For each application, the discovery module may also discover the version of the application. In the present context, an operating system is also regarded as an application.

Discovery module 60 may discover the currently-running applications in various ways. For example, the discovery module may examine the internal processes running in the VMs using memory introspection. This technique enables the discovery module to examine the memories and virtual disks of the VMs.

In the Kernel-based Virtual Machine (KVM) virtualization environment, for example, the discovery module may use introspection Application Programming Interfaces (APIs) such as libvmi. The discovery module may discover application identities, for example, by comparing the processes in the VM memory to a database of known processes. The comparison may comprise, for example, comparing an image hash or a memory-footprint hash.

In some embodiments, the database of known processes, images, memory footprints, or other information that enables the discovery module to identify the applications and versions, may be provided to the discovery module by central management unit 72. The central management unit may obtain updates of such information from any suitable source, and update the various discovery modules 60 as needed.

Additionally or alternatively, discovery module 60 may discover the identities of the applications by examining the traffic of the VMs and identifying traffic that indicates the application and possibly the version. For example, some applications send a “banner” containing the application identity and version number, as part of the application network protocol. The discovery module may intercept such a banner and extract the application identity therefrom.

As yet another example, discovery module 60 may receive information regarding the identities of the applications from some management system, e.g., from an administrative tool or a cloud management system. Further additionally or alternatively, the discovery module may discover the identities of the currently-running applications in any other suitable way.

Having discovered the identities of the currently-running applications, the discovery module checks whether the identities have changed since the previous discovery cycle, at a change checking step 88. If no change has occurred, the discovery module concludes that local signature database 68 is valid and up-to-date, and the method loops back to step 80 above.

If a change in the application identities is found (e.g., one or more newly-invoked applications are discovered, and/or one or more previously-running applications have stopped), discovery module 60 obtains an update to local signature database 68, at an update retrieval step 92. Discovery module 60 typically indicates the change to central management unit 72 and requests an update over network 28.

Central management unit 72 typically maintains an up-to-date list of known signatures, for various applications and versions, in global signature database 76. Unit 72 may receive signature updates from any suitable source, such as from various Internet sites or services. In response to the request, unit 72 sends the requested update to hypervisor 32 over network 28.

As explained above, in some embodiments local signature database 68 comprises a state-machine or other data structure that is compiled by unit 72 and then embedded in local search engine 64. In these embodiments, in response to the update request, unit 72 re-compiles the data structure and sends the re-compiled data structure to the hypervisor. Re-compiling the data structure may involve adding one or more new signatures, and/or removing one or more obsolete signatures.

At a signature updating step 96, local search engine 64 updates local signature database 68 in accordance with the update received from central management unit 72. In some embodiments, the update involves re-embedding the signature database into the search engine. The actual embedding operation depends on the specific implementation of the search engine and of the signature database. In an example embodiment, the signature database is compiled into a loadable executable library, such as Dynamic-Link Library (DLL).

The method then loops back to step 80 above, in which search engine 64 continues to search the traffic using the updated local signature database.

In various embodiments, discovery module 60 may initiate re-discovery of the application identities in response to various triggers or events. In some embodiments, discovery is performed at periodic intervals, e.g., every hour. Discovery may be initiated in response to an administrator request, e.g., when the administrator is aware of a change.

As another example, discovery may be triggered by an internal trigger in a VM, for example a trigger that indicates that a new process has started or that a process has stopped. Discovery module 60 may detect such an internal trigger, for example, using VM memory introspection. As yet another example, discovery may be triggered by an event occurring in the hypervisor, such as addition or removal of a VM. The discovery module may receive such a trigger from the hypervisor, or from an external source such as a cloud management system.

As another example, discovery may be triggered by a trigger from central management unit 72 in response to a change in the global signature database. For example, the central management unit may update the local search engine with a newly received signature. Further additionally or alternatively, discovery module may initiate a discovery process in response to any other suitable event.

As noted above, central management unit 72 typically maintains up-to-date information regarding known signatures in global signature database 76. Unit 72 may connect to its information sources periodically and/or in response to some event, in order to obtain signature updates or to replace the entire global database with an updated version of all known signatures. Typically, each signature is accompanied with an indication of the applications and specific versions for which the signature is relevant.

Upon receiving an update, unit 72 typically examines which updates should be made to which local signature database 68. For this purpose, unit 72 may use information provided by local discovery modules 60 regarding currently-running applications the various hosts. Additionally or alternatively, unit 72 may query the discovery modules for this information. Unit 72 may then update local signature databases 68 accordingly.

Although the embodiments described herein mainly address intrusion detection and prevention, the methods and systems described herein can also be used in other applications, such as for detection of insecure applications. Consider, for example, a scenario in which a VM begins to run an application that is found to have many associated signatures. Such an application may be regarded as highly insecure, because of the large number of relevant threats. The disclosed techniques can be used for detecting such a scenario and taking action, e.g., alerting an administrator that an insecure application is in use.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
discovering identities of one or more applications that run on one or more Virtual Machines (VMs) at a given time;
selecting a set of signatures, which characterize hostile traffic that is expected to threaten the discovered applications; and
searching network traffic exchanged with the one or more VMs for the hostile traffic, using the selected set of signatures.

2. The method according to claim 1, wherein discovering the identities, selecting the signatures and searching the network traffic are performed by a hypervisor that hosts the one or more VMs.

3. The method according to claim 1, wherein discovering the identities comprises identifying a newly-invoked application, and wherein selecting the signatures comprises requesting an external source to update the set with one or more signatures associated with the newly-invoked application.

4. The method according to claim 1, wherein discovering the identities comprises identifying an application that previously ran but no longer runs on the one or more VMs, and wherein selecting the signatures comprises removing one or more signatures associated with the application from the set.

5. The method according to claim 1, wherein discovering the identities of the applications comprises examining processes running in the VMs using memory introspection.

6. The method according to claim 1, wherein discovering the identities of the applications comprises identifying communication traffic of the VMs that is indicative of the applications that run on the VMs.

7. The method according to claim 1, wherein discovering the identities of the applications comprises receiving the identities of the applications from a management system.

8. The method according to claim 1, wherein the set of signatures is embedded as a data structure in a search-engine software that searches the network traffic.

9. The method according to claim 8, and comprising, in response to detecting a change in the identities of the applications, requesting an external source for an updated version of the data structure, and embedding the updated version in the search-engine software.

10. The method according to claim 1, wherein discovering the identities comprises initiating discovery of the identities in response to a predefined trigger.

11. The method according to claim 10, wherein the predefined trigger comprises at least one trigger type selected from a group of types consisting of:
a periodic re-discovery cycle;
an administrator request;
addition or removal of an application in one or more of the VMs;
addition or removal of one of the VMs; and
a change in a global database of the signatures.

12. Apparatus, comprising:
a memory for storing traffic signatures; and
a processor, which is configured to discover identities of one or more applications that run on one or more Virtual Machines (VMs) at a given time, to select and store in the memory a set of signatures, which characterize hostile traffic that is expected to threaten the discovered applications, and to search network traffic exchanged with the one or more VMs for the hostile traffic, using the selected set of signatures.

13. The apparatus according to claim 12, wherein the processor is configured to run a hypervisor that hosts the one or more VMs, discovers the identities, selects the signatures and searches the network traffic.

14. The apparatus according to claim 12, wherein the processor is configured to identify a newly-invoked application, and to request an external source to update the set of signatures with one or more signatures associated with the newly-invoked application.

15. The apparatus method according to claim 12, wherein the processor is configured to identify an application that previously ran but no longer runs on the one or more VMs, and to remove one or more signatures associated with the application from the set.

16. The apparatus according to claim 12, wherein the processor is configured to discover the identities of the applications by examining processes running in the VMs using memory introspection.

17. The apparatus according to claim 12, wherein the processor is configured to discover the identities of the applications by identifying communication traffic of the VMs that is indicative of the applications that run on the VMs.

18. The apparatus according to claim 12, wherein the processor is configured to receive the identities of the applications from a management system.

19. The apparatus according to claim 12, wherein the set of signatures is embedded as a data structure in a search-engine software that searches the network traffic.

20. The apparatus according to claim 19, wherein, in response to detecting a change in the identities of the applications, the processor is configured to request an external source for an updated version of the data structure, and to embed the updated version in the search-engine software.

21. The apparatus according to claim 12, wherein the processor is configured to initiate discovery of the identities in response to a predefined trigger.

22. The apparatus according to claim 21, wherein the predefined trigger comprises at least one trigger type selected from a group of types consisting of:
a periodic re-discovery cycle;
an administrator request;
addition or removal of an application in one or more of the VMs;
addition or removal of one of the VMs; and
a change in a global database of the signatures.

23. A system, comprising multiple hosts, each host configured to run one or more respective Virtual Machines (VMs), to discover identities of one or more applications that run on the Virtual Machines (VMs) in the host at a given time, to select a respective set of signatures that characterize hostile traffic that is expected to threaten the discovered applications, and to search network traffic exchanged with the one or more VMs in the host for the hostile traffic, using the selected set of signatures.
